(19) United States
(12) Patent Application Publication
(10) Pub. No.: US 2025/0253105 A1
(43) Pub. Date: Aug. 7, 2025

(54) AN ADAPTER FOR A CIRCUIT BREAKER OF A POWER SYSTEM

(71) Applicant: Vertiv Corporation, Westerville, OH (US)

(72) Inventors: Kishan Jaysukh-bhai JETHVA, Westerville, OH (US); Mahesh PIMPALE, Ahmednagar (IN); Nayush Sanjay BURADKAR, Westerville, OH (US)

(21) Appl. No.: 19/042,235

(22) Filed: Jan. 31, 2025

(30) Foreign Application Priority Data
Feb. 1, 2024 (IN) 202421000197

(51) Int. Cl. H01H 9/02

(52) U.S. Cl. CPC H01H 9/02

(57) ABSTRACT

A system that includes: at least one electrical circuit breaker of a power system, the at least one electrical circuit breaker defined by a body having at least one guideway and a breaker switch disposed on a first surface of the at least one electrical circuit breaker; and an adaptor defined by a housing having: an interior portion that includes a plurality of ridge structures adapted to secure the adaptor to the first surface of the at least one electrical circuit breaker; and at least one sleeve configured to allow passage of a cable from a first surface of the housing toward the interior portion of the housing.

### CROSS REFERENCE TO RELATED APPLICATIONS

This U.S. Non-Provisional Patent application claims the benefit of Indian Provisional Patent Application No. 202421000197 titled “An Adapter For A Circuit Breaker Of A Power System” filed Feb. 1, 2024, the entire disclosure of which is hereby incorporated by reference.

### FIELD

The present disclosure relates to an adapter for a circuit breaker of a powersystem.

### BACKGROUND

Typically, electronic components incorporate a plurality of circuit breakers interconnected via a plurality electrical cable. These cables are directly affixed to an operative end of the circuit breaker by passing therethrough. However, this direct attachment of cables to the operative end induces both electrical and mechanical stresses on individual circuit breakers, ultimately causing disengagement from its original positions.

Further, the direct mounting of cables onto the circuit breaker results in the cables obstructing breaker switch, which thereby results in a limited access to the breaker switch and creates restriction for replacing the breakers. Additionally, the cables are guided and routed over tie-rods after passing through the circuit breaker. Therefore, during maintenance and repair of the circuit breaker, it is required to remove the tie-rod before removing the circuit breaker from the electronic component which is a cumbersome and time-consuming process.

### SUMMARY

An aspect of the disclosed embodiments includes a system that includes: at least one electrical circuit breaker of a power system, the at least one electrical circuit breaker defined by a body having at least one guideway and a breaker switch disposed on a first surface of the at least one electrical circuit breaker; and an adaptor defined by a housing having: an interior portion that includes a plurality of ridge structures adapted to secure the adaptor to the first surface of the at least one electrical circuit breaker; and at least one sleeve configured to allow passage of a cable from a first surface of the housing toward the interior portion of the housing.

### BRIEF DESCRIPTION OF THE ACCOMPANYING DRAWING

The adapter, of present disclosure, for a circuit breaker of a power system will now be described with the help of the accompanying drawing, in which:

FIG. 1 illustrates an arrangement of a plurality of circuit breaker along multiple shelves of an electronic component in accordance with the prior art;

FIG. 2 illustrates a conventional mounting arrangement of cables to an operative end of the plurality of circuit breakers and subsequent guiding or routing of these cables along a tie rod of FIG. 1;

FIG. 3 illustrates the arrangement of the plurality of circuit breaker along multiple shelves of the electronic component;

FIG. 4 illustrates the isometric view of a circuit breaker of FIG. 3;

FIG. 5 illustrates an arrangement of flange for the alignment of the circuit breaker and thermal management of FIG. 1;

FIG. 6 illustrates the circuit breaker with an adapter attached thereon in accordance with some embodiments of the present disclosure;

FIG. 7 illustrates the plurality of the circuit breakers with the adapter attached thereon and the cable mounted to an operative end of the adapter of FIG. 6;

FIG. 8 illustrate an isometric view of the circuit breaker with the adapter attached thereon of FIG. 6;

FIG. 9 illustrate an isometric exploded view of the circuit breaker with the adapter of FIG. 8;

FIG. 10 illustrate an isometric back view of the adapter of FIG. 9;

FIG. 11A and FIG. 11B illustrates a conventional mounting arrangement of cables to an operative end of the plurality of circuit breakers and subsequent guiding or routing of these cables along a tie rod of FIG. 1; and

FIG. 12A and FIG. 12B illustrates a novel mounting arrangement of cables to an operative end of the plurality of circuit breakers by means of the circuit breakers in accordance with the present disclosure.

### DETAILED DESCRIPTION

Embodiments, of the present disclosure, will now be described with reference to the accompanying drawing.

Embodiments are provided so as to thoroughly and fully convey the scope of the present disclosure to a person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units, and/or components, but do not forbid the presence or addition of one or more other features, elements, components, and/or groups thereof.

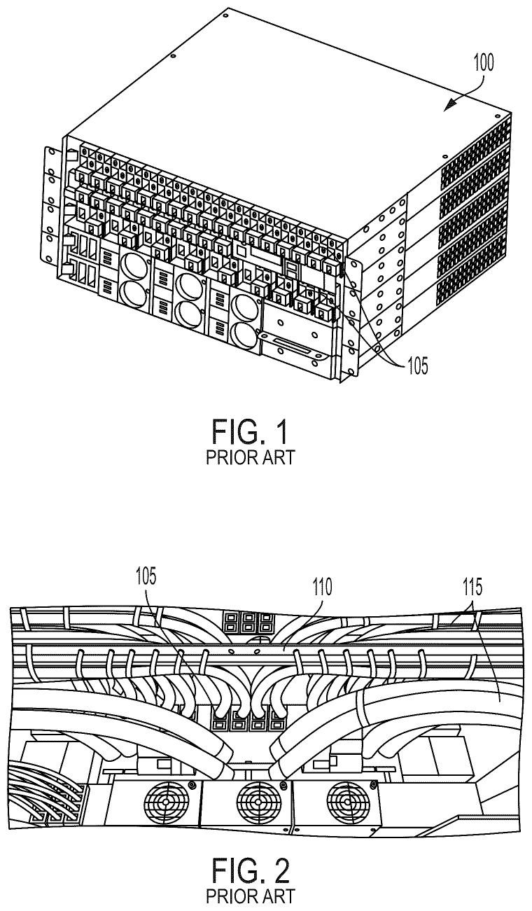

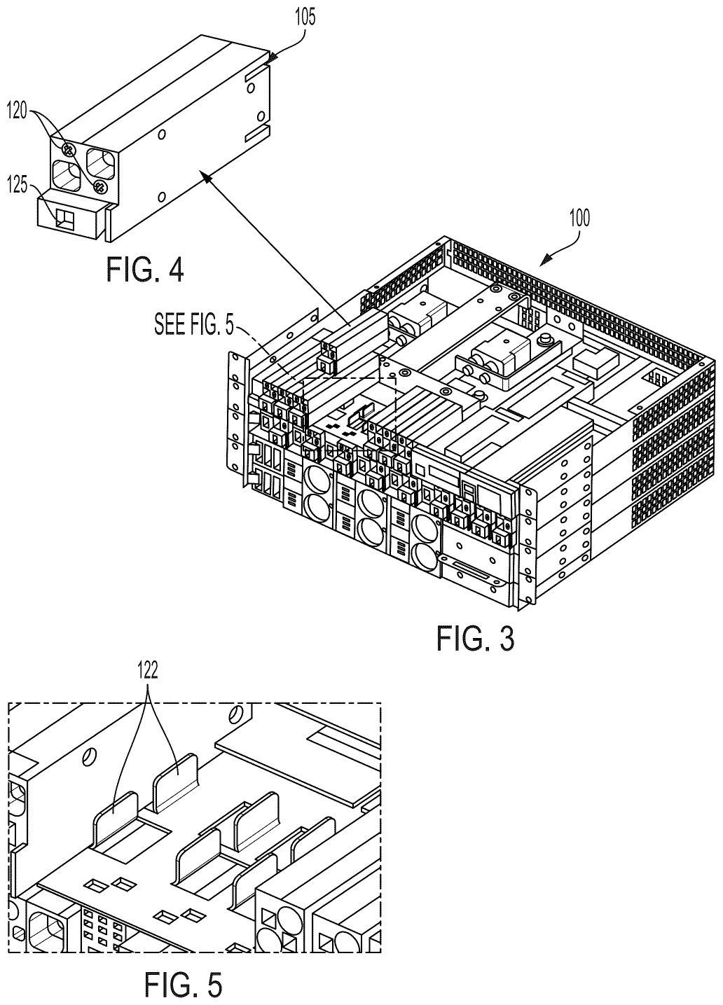

Typically, electronic components (100) incorporate a plurality of circuit breakers (105) interconnected via a plurality electrical cable (115). These cables (115) are directly affixed to an operative end of the circuit breaker (105) by passing therethrough. FIG. 1 illustrates an arrangement of a plurality of circuit breaker (105) along multiple shelves of a power system (100) in accordance with the prior art. FIG. 2 illustrates a conventional mounting arrangement of cables (115) to an operative end of the plurality of circuit breakers (105) and subsequent guiding or routing of these cables (115) along a tie rod of FIG. 1. However, this direct attachment of the cables (115) to the operative end induces both electrical and mechanical stresses on individual circuit breakers (105), ultimately causing disengagement from its original positions. FIG. 3 illustrates the arrangement of the plurality of circuit breaker (105) along multiple shelves of the power system (100).

Further, the direct mounting of the cables (115) onto the circuit breaker (105) results in the cables (115) obstructing breaker switch (125), which thereby results in a limited access to the breaker switch (125) and creates restriction for replacing the breakers. FIG. 4 illustrates the isometric view of a circuit breaker (105) of FIG. 3. FIG. 5 illustrates an arrangement of flange (122) for the alignment of the circuit breaker (105) and thermal management of FIG. 1. Additionally, the cables (115) are guided and routed over tie-rods (110) after passing through the circuit breaker (105). Therefore, during maintenance and repair of the circuit breaker (105), it is required to remove the tie-rod (110) before removing the circuit breaker (105) from the electronic component (100) which is a cumbersome and time-consuming process.

Therefore, the present disclosure envisages an adapter (150) for a circuit breaker (105) of a power system (100) (herein after referred as adapter (150)). The circuit breaker (105) may be configured to slide within a plurality of shelves provided in the power system (100). The circuit breaker (105) may be defined by a body with at least a pair of guideways (107) and a breaker switch (125) on an operative front surface. The guideway (107) serves as channels, allowing the insertion of the cables (115) to maintain the necessary electrical connection. The adapter (150) may be configured to be attached to an operative portion of the circuit breaker (105) to enhance the cable (115) mounting to the circuit breaker (105) to prevent disengagement of the cable (115) from the original position and thus to minimize any electrical and mechanical stresses on the individual circuit breakers (105).

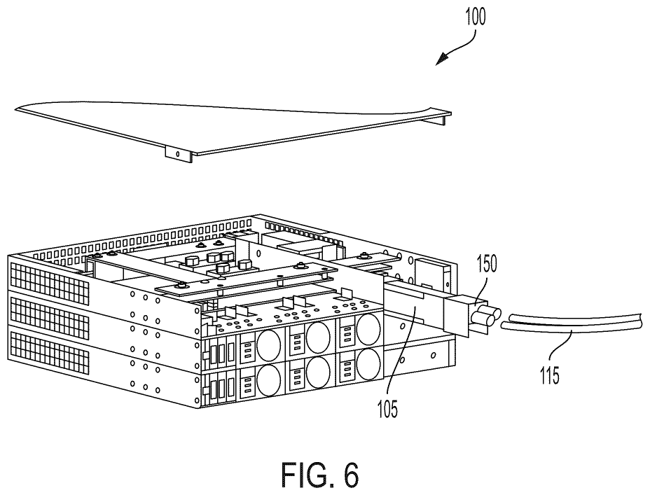

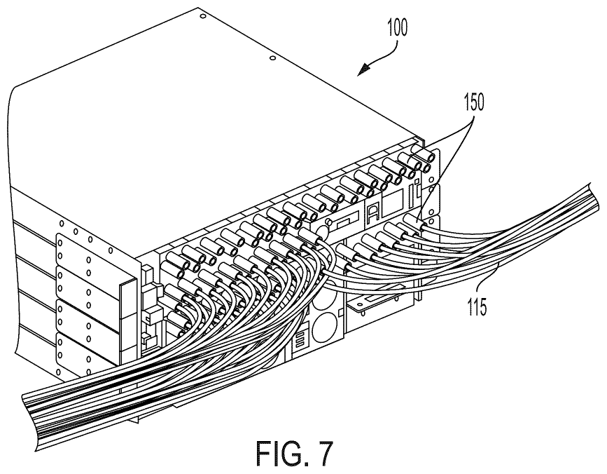

FIG. 6 illustrates the circuit breaker (105) with an adapter (150) attached thereon in accordance with some embodiments of the present disclosure. FIG. 7 illustrates the plurality of the circuit breakers (105) with the adapter (150) attached thereon and the cable (115) mounted to an operative end of the adapter (150) of FIG. 6.

In some embodiments, the guideway (107) extends along the length of the circuit breaker (105) to guide the cable (115) across the circuit breaker (105) to enable the electrical connection.

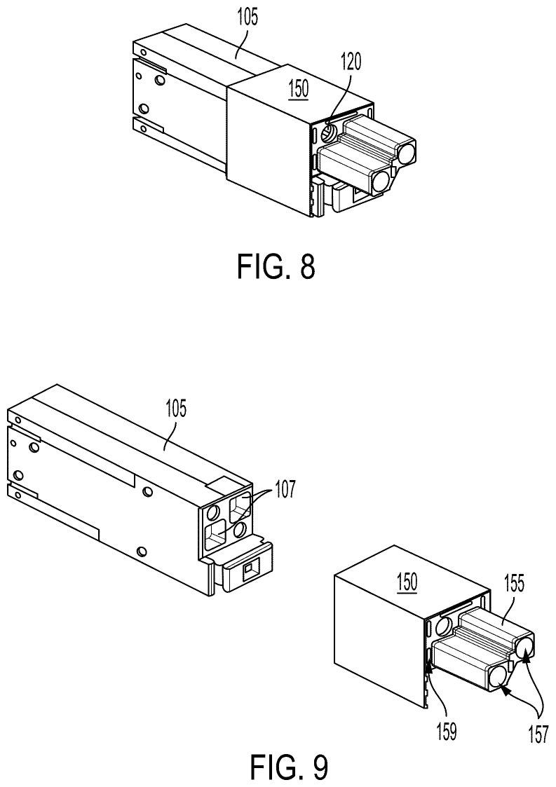

The adapter (150) of the present disclosure is explained with reference to FIG. 8 to FIG. 10. FIG. 8 illustrate an isometric view of the circuit breaker (105) with the adapter (150) attached thereon of FIG. 6. The adapter (150) may be defined by a housing (153) with at least a pair of sleeves (155) extending outward from an operative front surface. The sleeves (155) may be configured with an aperture (157) to receive a predefined size of the cable (115) therethrough. The sleeve (155) may be allowed to protrude inwardly, facilitating the passage of the cable (115) from the front surface towards the interior of the housing (153) through the sleeve (155). FIG. 9 illustrate an isometric exploded view of the circuit breaker (105) with the adapter (150) of FIG. 8.

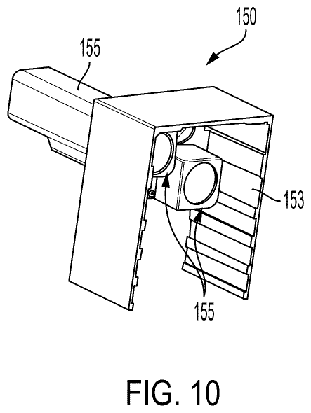

In some embodiments, the operative front surface of the adapter (150) may be configured with a plurality of cavities (159) along the outer edge of the adapter (150). Advantageously, these cavities facilitate air circulation back-and-forth though the adapter (150). In addition, the adapter ensures to maintain the gap between two adjacent circuit breakers. Consequently, it effectively maintains the thermal equilibrium of both, the circuit breaker (105) and the electronic component (100) in an operative configuration. FIG. 10 illustrate an isometric back view of the adapter (150) of FIG. 9.

In some embodiments, the inner surface of the adapter (150) housing (153) may be configured with a plurality of ridges. These ridges facilitate the secure snap-fit attachment of the adapter (150) on the operative front surface of the circuit breaker (105). Therefore, during snap-fitting, allowing the inward extended portion of the sleeves (155) to be seamlessly accommodated within the guideways (107), to thereby the guideways (107) of the adapter (150) becomes in-line with the aperture (157) of the sleeves (155) of the adapter (150). Thus, this alignment facilitates the passage of cables (115) from the sleeve (155) of the adapter (150) into the guideway (107) of the circuit breaker (105), establishing a streamlined and efficient connection. Advantageously, the sleeves (155) of the adapter (150) provide firm gripping of the cables (115) during operative configuration, and thus prevents accidental disengagement of the cable (115) from the original position.

In some embodiments, the adapter (150) may be configured to be fastened on the operative front surface of the circuit breaker (105) by means of a plurality of fasteners (120).

In some embodiments, since the cables (115) are routed and guided by the adapter (150), therefore there is no requirement of the tie-rod (110) to hold the cable (115) at its position.

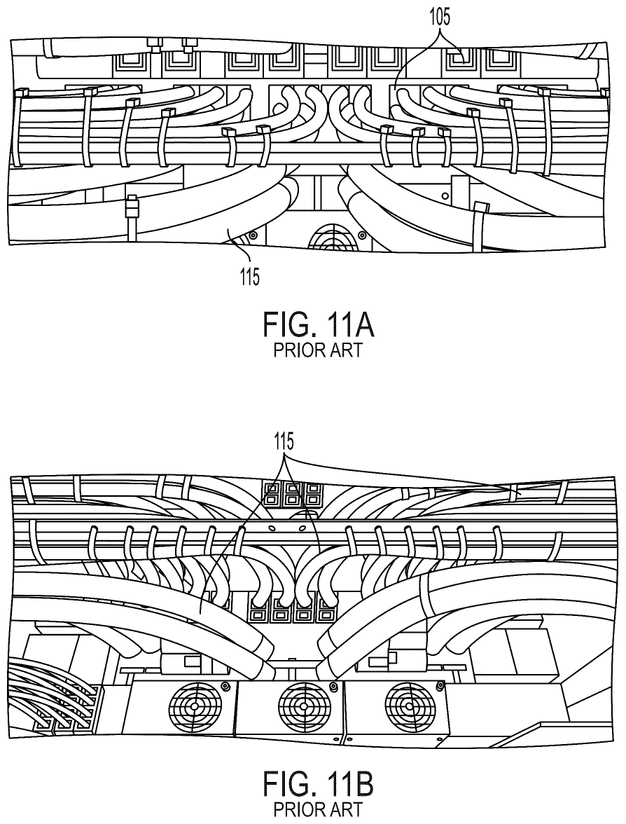

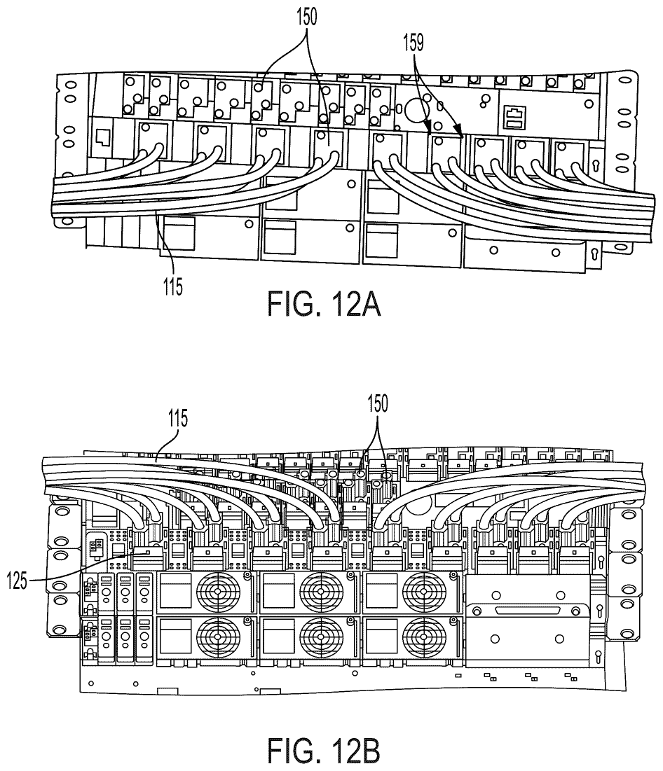

In some embodiments, the operative front surface of the housing (153) may be configured with a cut-out. Therefore, during mounting configuration of the adapter (150) on the circuit breaker (105), the break switch protrudes out from the cut-out to enable ease of visibility. FIG. 11A and FIG. 11B illustrates a conventional mounting arrangement of cables (115) to an operative end of the plurality of circuit breakers (105) and subsequent guiding or routing of these cables (115) along a tie rod of FIG. 1. FIG. 12A and FIG. 12B illustrates a novel mounting arrangement of cables (115) to an operative end of the plurality of circuit breakers (105) by means of the circuit breakers (105) in accordance with the present disclosure.

In some embodiments, the systems and methods described herein may be configured to enhance the cable mounting to the circuit breaker to minimize electrical and mechanical stresses on individual circuit breakers. The systems and methods described herein may be configured to prevent disengagement of the cable form the original position. The systems and methods described herein may be configured to avoid obstructing the breaker switch, ensuring unhindered access, and facilitating easier replacement of circuit breakers. The systems and methods described herein may be configured to provide a quick-release mechanism for cable attachments to expedite maintenance procedures and reduce the time spent on the removal and reinstallation of circuit breakers. The systems and methods described herein may be configured to provide modular configuration for easy replacement, to thereby reduce system downtime during maintenance.

The systems and methods described herein may be configured to be easily installed and removed, addressing the need for a hassle-free solution during maintenance and repair activities. The systems and methods described herein may be configured to maintain the gap between two adjacent circuit breakers for thermal requirement. The systems and methods described herein may be configured to enhance circuit breaker accessibility and stability.

The systems and methods described herein may be configured to provide an adapter for a circuit breaker of a power system which can enhance the cable mounting to the circuit breaker to minimize electrical and mechanical stresses on individual circuit breakers. The systems and methods described herein may be configured to provide an adapter for a circuit breaker that can prevent disengagement of the cable from the original position. The systems and methods described herein may be configured to provide an adapter for a circuit breaker that can avoid obstructing the breaker switch, ensuring unhindered access, and facilitating easier replacement of circuit breakers. The systems and methods described herein may be configured to provide an adapter for a circuit breaker that can enhance accessibility to the breaker switch, allowing for efficient operation and maintenance without compromising on safety.

The systems and methods described herein may be configured to provide an adapter for a circuit breaker that can provide a quick-release mechanism for cable attachments to expedite maintenance procedures and reduce the time spent on the removal and reinstallation of circuit breakers. The systems and methods described herein may be configured to provide an adapter for a circuit breaker that can provide modular configuration for easy replacement, to thereby reduce system downtime during maintenance. The systems and methods described herein may be configured to provide an adapter for a circuit breaker that can be easily installed and removed, addressing the need for a hassle-free solution during maintenance and repair activities. The systems and methods described herein may be configured to provide an adapter for a circuit breaker that can facilitate thermal management of the circuit breaker.

The foregoing description of the embodiments has been provided for purposes of illustration and not intended to limit the scope of the present disclosure.

Individual components of a particular embodiment are generally not limited to that particular embodiment but are interchangeable. Such variations are not to be regarded as a departure from the present disclosure, and all such modifications are considered to be within the scope of the present disclosure.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprises”, or variations such as “comprises” or “comprising”, will be understood to imply the inclusion of a stated element, or group of elements, but not the exclusion of any other element, or group of elements.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A system comprising:
at least one electrical circuit breaker of a power system, the at least one electrical circuit breaker defined by a body having at least one guideway and a breaker switch disposed on a first surface of the at least one electrical circuit breaker; and
an adaptor defined by a housing having:
an interior portion that includes a plurality of ridge structures adapted to secure the adaptor to the first surface of the at least one electrical circuit breaker; and
at least one sleeve configured to allow passage of a cable from a first surface of the housing toward the interior portion of the housing.

2. The system of claim 1, wherein the at least one electrical circuit breaker is configured to be retained in one of a plurality of shelves of the power system.

3. The system of claim 1, wherein the at least one guideway defines a channel configured to allow the cable to connect to an electrical connection of the power system.

4. The system of claim 1, wherein the at least one guideway extends along a length of the at least one electrical circuit breaker.

5. The system of claim 1, wherein the at least one sleeve extends outward from the first surface of the housing.

6. The system of claim 1, wherein the at least one sleeve includes at least a pair of sleeves.

7. The system of claim 1, wherein the at least one sleeve includes aperture adapted to receive the cable.

8. The system of claim 1, wherein the first surface of the housing may include at least one cavity that facilitates air circulation through the interior portion of the housing.

9. The system of claim 8, wherein the at least one cavity is disposed on an edge of the housing.

10. The system of claim 8, wherein the housing includes at least one two cavities.

11. The system of claim 1, wherein the adaptor is configured to maintain a gap between the at least one electrical circuit breaker and at least one other electrical circuit breaker.

12. The system of claim 11, wherein the at least one electrical circuit breaker is disposed in the power system adjacent to the at least one other electrical circuit breaker.

13. The system of claim 1, wherein the plurality of ridge structures provide a snap-fit connection to secure the adaptor to the first surface of the at least one electrical circuit breaker.

14. The system of claim 13, wherein the snap-fit connection allows the at least one sleeve to be received by the at least one guideway.

15. The system of claim 1, wherein the body includes a plurality of guideways.
